(19) United States
(12) Patent Application Publication
(10) Pub. No.: US 2009/0174816 A1
(43) Pub. Date: Jul. 9, 2009

(54) Method And System For Detection Of Video Connections

(76) Inventors: Tim Hellman, Concord, MA (US); Jiangfeng Wu, Aliso Viejo, CA (US); Hans Eberhart, Hermosa Beach, CA (US)

Correspondence Address: MCANDREWS HELD & MALLOY, LTD, 500 WEST MADISON STREET, SUITE 3400, CHICAGO, IL, 60661, US

(21) Appl. No.: 12/117,916

(22) Filed: May 9, 2008

Related U.S. Application Data
(60) Provisional application No. 61/019,676, filed on Jan. 8, 2008.

(51) Int. Cl. H04N 5/44

(52) U.S. Cl. 348/553; 348/E05.096

(57) ABSTRACT

Aspects of a method and system for detection of video connections are provided. In this regard, a pulse of current may be applied to a video interface and a voltage differential resulting from the applied current pulse may be measured to determine whether the video interface is connected to a video device. The current pulse may be a Hsync pulse of a video signal which may occur during a vertical blanking time of the video signal. A voltage differential resulting from each of a plurality of Hsync pulses occurring over one or more frames of said video signals may be measured. The current pulse may be a pulse in a pulse train. A voltage differential resulting from each of a plurality of pulses in a pulse train occurring over a period of time may be measured. Video signals to unconnected video interfaces may be disabled

### CROSS-REFERENCE TO RELATED APPLICATIONS/INCORPORATION BY REFERENCE

This patent application makes reference to, claims priority to and claims benefit from U.S. Provisional Patent Application Ser. No. 61019676 filed on Jan. 8, 2008.

The above stated application is hereby incorporated herein by reference in its entirety.

### FIELD OF THE INVENTION

Certain embodiments of the invention relate to signal processing. More specifically, certain embodiments of the invention relate to a method and system for detection of video connections.

### BACKGROUND OF THE INVENTION

Video source devices support a variety of analog video interfaces. In this regard, component video (3 channels such as RGB or YPbPr) is an exemplary analog interfaces which may support standard-definition (SD) and high-definition (HD) formats. Conversely, composite video and S-Video interfaces may only support SD formats.

Conventional video sources may have no way to determine which analog video interfaces are actually connected at any given time and conventional video sources typically address this shortcoming in one of two ways. The first way conventional video sources deal with the inability to detect connected interfaces, is to require a user to manually select an interface. However, manual selection of an interface often leads to a less than desirable user experience. For example, user inexperience or unfamiliarity with the video source may result in the user being unable to correctly or quickly select an appropriate interface. The second way conventional video systems deal with the inability to detect connected interfaces, is to drive all analog interfaces simultaneously. However, driving all analog interfaces simultaneously may also negatively impact the video system. For example, the need to re-format SD content for an HD interface and the different latencies of the different signal paths may lead to undesirable video artifacts. Additionally, simultaneously driving all analog interfaces may increase cost and power consumption of the video source due to the presence and operation of increased and/or redundant circuitry. In this regard, battery life of portable systems may be significantly shortened when multiple analog video interfaces are driven.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for detection of video connections, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is diagram illustrating analog interfaces between a video source and a video receiver, in accordance with an embodiment of the invention.

FIG. 2 is a diagram illustrating sync signals associated with SD and HD video, in connection with an embodiment of the invention.

FIGS. 3A and 3B illustrate signals at a video interface in instances that the interface is connected and unconnected, respectively, in accordance with an embodiment of the invention.

FIG. 4 is a diagram of an exemplary system for detecting connection status of a video interface, in accordance with an embodiment of the invention,

FIG. 5A is a diagram of an exemplary video source enabled to detect video connections, in accordance with an embodiment of the invention.

FIG. 5B is a diagram of another exemplary video source enabled to detect video connections, in accordance with an embodiment of the invention.

FIG. 6 is a flowchart illustrating exemplary steps for detecting connected video interfaces, in accordance with an embodiment of the invention.

### DETAILED DESCRIPTION OF THE INVENTION

Certain embodiments of the invention may be found in a method and system for detection of video connections. In this regard, a pulse of current may be applied to a video interface and a voltage differential resulting from the applied current may be measured to determine whether the video interface is connected to a video device, such as a video receiver. In instances the video interface is connected vs. unconnected, the output impedance at the interface may be lower and may result in the measured differential being lower. The voltage differential may be measured by sampling a voltage on the interface during the current pulse and subtracting the sampled voltage from a voltage on the interface subsequent to the current pulse. In instances that the voltage may be less than a threshold, the interface may be determined to be connected. In instances that the voltage differential may be greater than a threshold, the video interface may be determined to be unconnected. The current pulse may be a Hsync pulse of a video signal which may occur during a vertical blanking time of the video signal. In this regard, a voltage differential resulting from each of a plurality of Hsync pulses occurring over one or more frames of said video signals may be measured. The current pulse may be a pulse in a pulse train. In this regard, a voltage differential resulting from each of a plurality of pulses in a pulse train occurring over a period of time may be measured. A pulse train, instead of a video signal, may be applied to a video interface in instances that the interface may be unconnected. In various embodiments of the invention, video signals to unconnected video interfaces may be disabled.

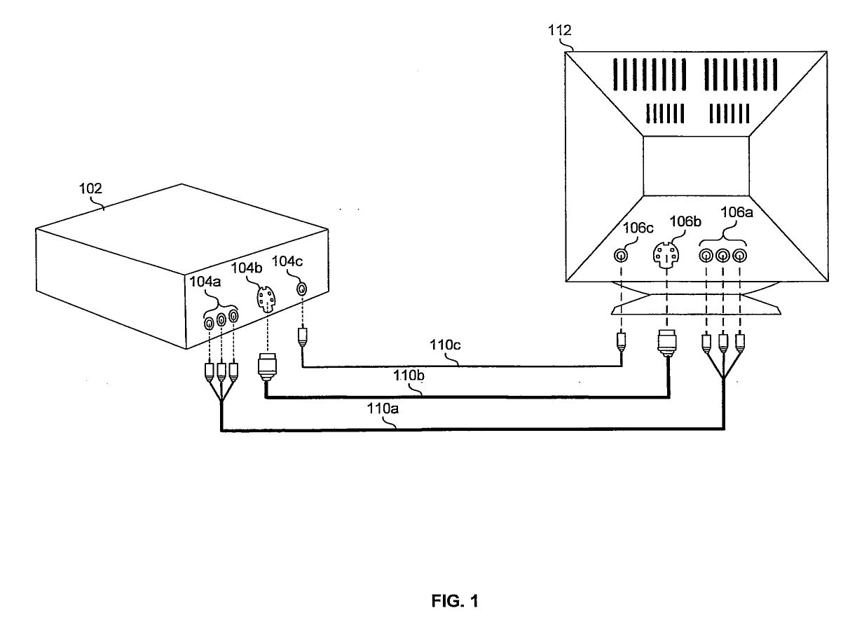

FIG. 1 is diagram illustrating analog interfaces between a video source and a video receiver, in accordance with an embodiment of the invention. Referring to FIG. 1 there is shown a video source 102, video cables 110a, 110b, and 110c (collectively referred to herein as cables 110), and a video receiver 112.

The video sources 102 may comprise suitable logic, circuitry, and/or code that may enable outputting video signals via one or more analog video interfaces. Exemplary video sources may comprise DVD players, high-definition optical disk players (such as Blu-Ray®), set-top boxes (e.g. satellite and cable boxes), and hard-drive and/or solid-state-memory based devices (e.g. digital video recorders). Exemplary analog interfaces may comprise composite video 104c, S-Video 104b, and component video 104a (collectively referred to herein as interfaces 104).

The cables 110 may comprise physical media for conveying video signals. Accordingly, each of the cables 110 may be terminated by connectors specified in the applicable video interface standards.

The video receiver 112 may comprise suitable logic, circuitry, and/or code for receiving and processing analog video signals. For example, the receiver may be (or be within) a television and may be enabled to process the received video signals for display on a monitor. In another example, the receiver 112 may be (or be within) a video recording device such as a DVD burner or a digital video recorder (DVR), and may be enabled to process the received video signals and store the video content. In another example, the video receiver 112 may be a signal distribution element such as a splitter or signal booster. The receiver 112 may receive video signals via one or more of the composite video 106c, S-Video 106b, and component video 106a interfaces.

In operation, the source 102 may connect to the receiver 112 via one or more of the cables 110. In this regard, the cable 110a may convey composite video signals from the interface 104a to the interface 106a, the cable 110b may convey S-video signals from the interface 104b to the interface 106b, and the cable 110c may convey component video signals from the interface 104c to the interface 106c. Aspects of the invention may enable the source 102 to detect which of the interfaces 104 may be coupled to a corresponding interface 106. Accordingly, the source 102 may output video signals on only the portion of the interfaces 104 that may be coupled to a corresponding interface 106. Furthermore, of the coupled interfaces 104, the source may be enabled to select a preferred interface.

In an exemplary embodiment of the invention, it may be detected that only the interface 104b may be connected. Consequently, the source 102 may only output an S-video signal, while the interfaces 104a and 104c remain idle.

In another exemplary embodiment of the invention, it may be detected that the interfaces 104a and 104c are both connected. Consequently, the source 102 may be enabled to intelligently determine which of the interfaces 104a and 104c to utilize. For example, the source 102 may output HD content via the interface 104a while the interfaces 104b and 104c remain idle and may output SD content via the interface 104c while the interfaces 104a and 104b remain idle.

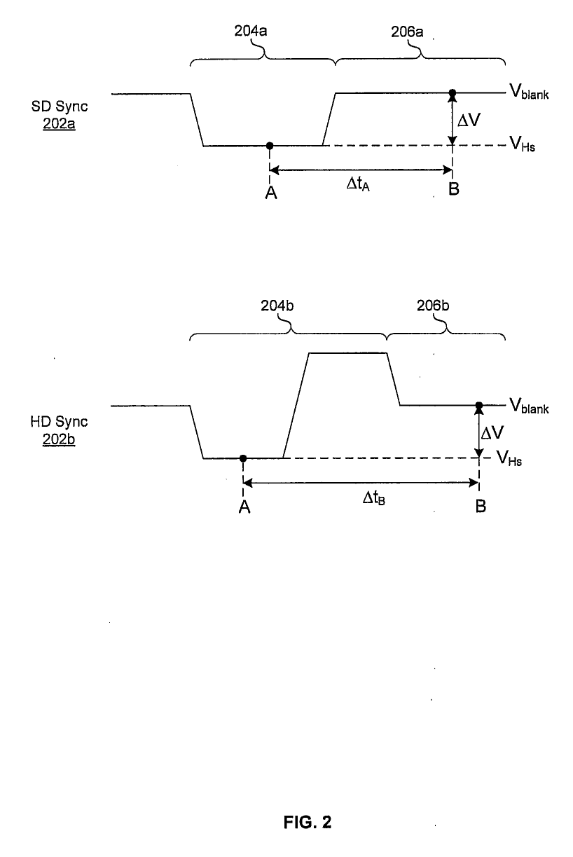

FIG. 2 is a diagram illustrating sync signals associated with SD and HD video, in connection with an embodiment of the invention. Referring to FIG. 2 there is shown a portion of a SD video signal 202a and a portion of a HD video signal 202b.

The portion of the SD video signal 202a shown in FIG. 2 comprises a horizontal sync (Hsync) pulse 204a, as defined in the SD video standards, followed by a blank period 206a. In this regard, although an Hsync, having amplitude VHS, may occur on each line of a video signal, the portion of the SD video signal 202a depicted in FIG. 2 may occur during a vertical blanking time, as defined in the SD video standards. In this manner, there may be minimal activity in the video signal at point B and the blank level, Vblank, may be accurately measured. Exemplary SD standards call for the voltage difference, ΔV, to be approximately 300 mV when connected to a video receiver.

The portion of the HD video signal 202b shown in FIG. 2 comprises a horizontal sync (Hsync) pulse 204b, as defined in the SD video standards followed by a blank period 206b. In this regard, although an Hsync, having amplitude VHS, may occur on each line of a video signal, the portion of the HD video signal 202b depicted in FIG. 2 may occur during a vertical blanking time, as defined in the HD video standards. In this manner, there may be minimal activity in the video signal at point B and the blank level, V_{blank}, may be accurately measured. Exemplary HD standards call for the voltage difference, ΔV, to be approximately 300 mV when connected to a video receiver.

In operation, aspects of the invention may enable determining whether a video interface is being driven by a signal such as the signals 202 based on a value of ΔV. In this regard, V_{Hs} may be determined via a sample and hold of a voltage level on a video interface at time A. Subsequently, ΔV may be determined by subtracting V_{Hs} from a voltage level on the interface at time B. Because the width of the Hsync pulse may depend on the video format, the amount of time, Δt, between points A and B may be adjusted based on the video format. For example, the duration of the Hsync signal may range from approximately 500 ns for HD signals to approximately 2 us for SD signals.

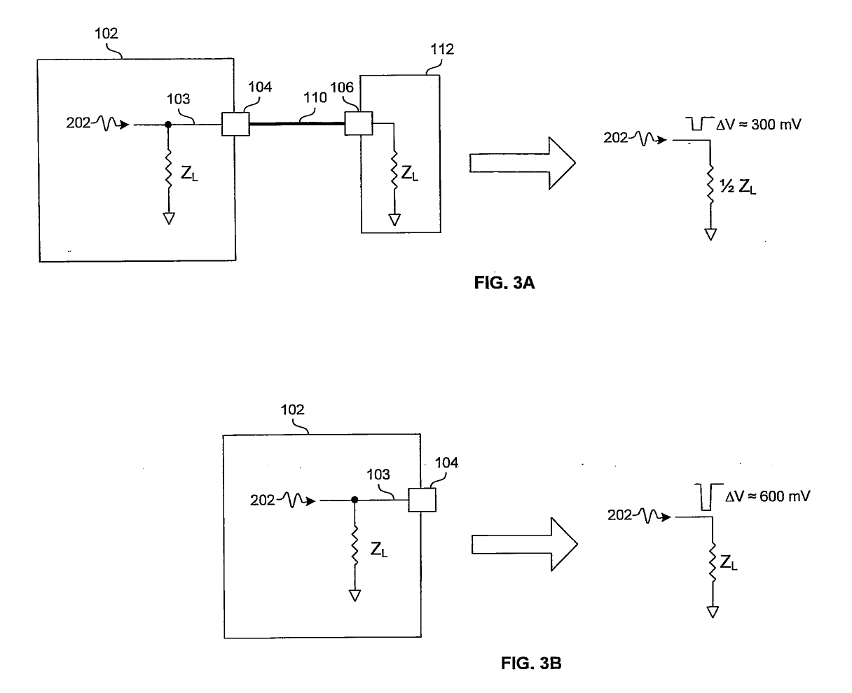

FIGS. 3A and 3B illustrate signal levels at a video interface in instances that the interface is connected and unconnected, respectively, in accordance with an embodiment of the invention. Referring to FIGS. 3A and 3B there is shown a video source 102, a video receiver 112, and a cable 110. Signals may be coupled to the interface 104 via a metal trace 103. The output impedance of the source 102 and the input impedance of the receiver 112 may be, Z_{L}, and may be specified by applicable standards. In this regard, the output impedance of the source 102 and the input impedance of the receiver 112 may be in parallel when the source 120 and the receiver are. Thus, when the interface 104 is connected, the resistance seen by the signal 202 may be approximately ½ Z_{L} (neglecting the resistance of the cable 110) and when the interface 104 is unconnected, the resistance seen by the signal 202 may be approximately Z_{L}.

In operation, the signal 202 may be incident on the interface 104. The current of the signal 202 may be established such that ΔV equals a value, V_{std}, as determined by the applicable standards, when the signal 202 is being driven into a receiver. Thus, in FIG, 3A, when the interface 104 is connected, the current of the signal 202 across ½ Z_{L} may result in ΔV equal to V_{std} (within a tolerance). However, in FIG. 3B, when the interface 104 is unconnected, the current of signal 202 across Z_{L} may result in ΔV equal to 2*V_{std} (within a tolerance). For example, various SD and HD formats may require ΔV, as described with respect to FIG. 2, to be 300 mV and Z_{L} to be 75 Ohms. Accordingly, ΔV at the interface 104 may be 300 mV when the interface is connected and 600 mV when the interface 104 is unconnected.

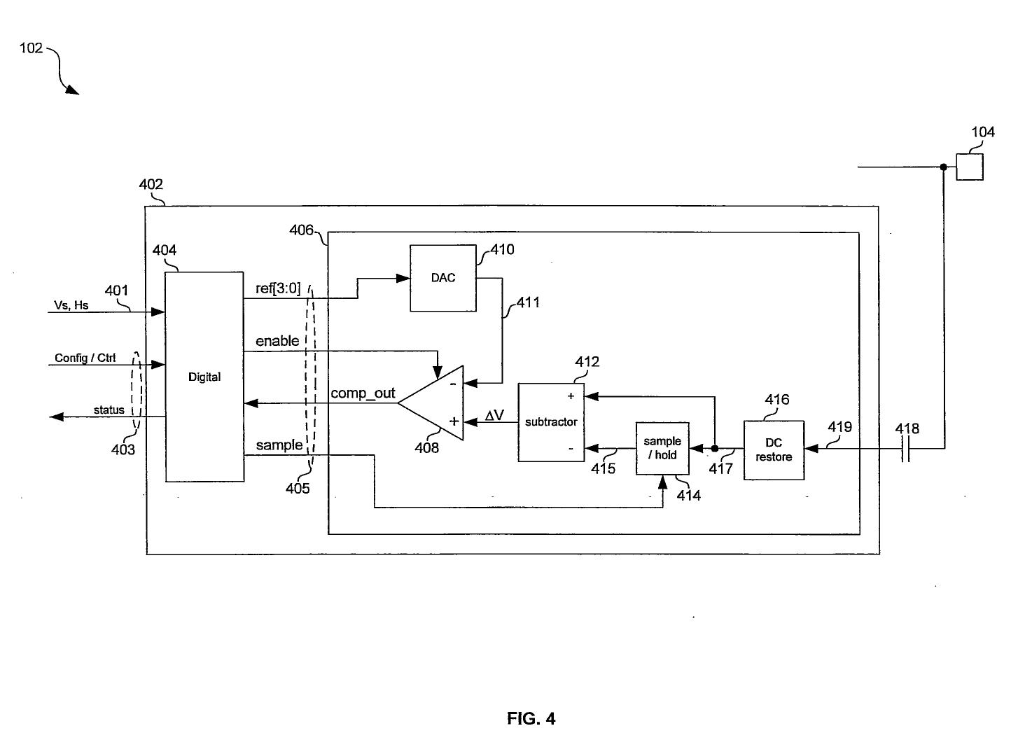

FIG. 4 is a diagram of an exemplary system for detecting connection status of a video interface, in accordance with an embodiment of the invention. Referring to FIG. 4 there is shown a portion of a video source 102 comprising a connection detect block 402 communicatively coupled, via the capacitor 418, to the interface 104. The connection detect block 402 may comprise a digital portion 404 and an analog portion 406. The analog portion 406 may comprise a comparator 408, a digital-to-analog converter (DAC) 410, a subtractor 412, a sample-and-hold circuit 414, and a level restoration block 416. The interface 104 may as described with respect to FIG. 1.

The capacitor 418 may enable AC coupling signals at the interface 104 to the connection detect block 402. In this manner, AC coupling via the capacitor 418 may prevent the connection detect block 402 from significantly affecting signals at the interface 104. However, in various embodiments of the invention, DC levels on the interface 104 may be known enabling omission of the capacitor 418 and DC coupling the connection detect block 402 to the interface 104.

The level restore block 416 may comprise suitable logic, circuitry, and/or code that may enable setting a DC level for the AC coupled signal 419. Accordingly, the output signal 417 of the level restore block 416 may have the same (ideally) AC characteristics of the signal 419 but with a known DC level that enables reliably processing the signal 417.

The sample-and-hold 414 may comprise suitable logic, circuitry, and/or code that may enable outputting a signal 415. In this regard, the signal 415 may sample or track the signal 417 while ‘sample’ is asserted and may remain fixed while ‘sample’ is de-asserted.

The subtractor 412 may comprise suitable logic, circuitry, and/or code that may enable subtracting the voltage of the signal 415 from the voltage of the signal 417 to generate ΔV. In an exemplary embodiment of the invention, the subtractor 412 may comprise a differential amplifier.

The comparator 408 may comprise suitable logic, circuitry, and/or code that may enable comparing ΔV with the reference voltage 411. In this regard, the signal “comp_out” may be asserted when ΔV is greater than reference voltage 411 and “comp_out” may be de-asserted when ΔV is less than the reference voltage 411. Additionally, the ‘enable’ signal may be a digital signal that may control operations of the comparator 408. In this regard, when ‘enable’ is asserted, a comparison may be performed and when “enable” is de-asserted the output of the comparator 408, coupled to “comp_out”, may be placed into a high impedance state. In an exemplary embodiment of the invention, ‘ref[3:0]’ may establish a reference voltage of approximately 450 mV.

The DAC 410 may comprise suitable logic, circuitry, and/or code that may enable converting digital signals to analog signals. In this regard, the DAC 410 may be enabled to convert the 4-bit word “ref[3:0]” into an analog reference voltage 411.

The digital portion 404 may comprise suitable logic, circuitry, and/or code that may enable controlling and/or configuring the analog portion 406. In this regard, the digital portion 404 may exchange information with the analog portion 406 via the signal bus 405 comprising signals ‘ref[3:0]’, ‘enable’, ‘comp_out’, and ‘sample’.

The digital portion 404 may also comprise suitable logic, circuitry, and/or code for processing information received from the analog portion 106 to generate one or more signals indicating a connection status of one or more interfaces.

The digital portion 404 may also comprise suitable logic, circuitry, and/or code that may enable exchanging information with a remainder of the video source 102. In this regard, the digital portion 104 may receive control and/or configuration information from, for example, a video processor. Additionally, the digital portion 104 may output, via the “status” signal in the data bus 403, an indication of whether or not interface 104 may be coupled to a video receiver. For example, the “status” signal may comprise a plurality of bits corresponding to the plurality of interfaces 104 in the video source 102. Accordingly, a bit in the “status” signal being asserted or de-asserted may indicate that a corresponding interface may be connected or disconnected, respectively.

In operation, the digital portion 404 may utilize Hsync and Vsync signals 401 to determine the format and/or timing of a video signal being transmitted to the interface 104. Based on the determined video format and/or timing, the digital portion 404 may assert “sample” and the voltage on the interface 104 at point A (see FIG. 2) may be sampled and output as signal 415. Accordingly, the value of the signal 415 may be fixed at this sampled value until the next time “sample” is asserted. The signal 415 may be continuously subtracted from the signal 417 via the subtractor 412 and output as ΔV. Accordingly, ΔV may change with the signal 417. Subsequently, an interval of Δt (see FIG. 2) after “sample” was enabled, the digital portion 404 may assert “enable” and a comparison between ΔV and the reference voltage 411 may be output onto “comp_out”. Accordingly, this value of “comp_out” may remain until the next time “enable” is asserted. In this regard, “comp_out” may be asserted in instances that ΔV is greater than the reference voltage 411 and may be de-asserted when ΔV is less than the reference voltage.

The digital portion 404 may generate the “status” signal based on “comp_out”. In this regard, the digital portion 404 may, for example, store the value of “comp_out” over multiple video frames and may determine the connection status of the interface 104 based on the number of times that ‘comp_out’ may be asserted vs. the number of times that ‘comp_out’ may be de-asserted. Consequently, in instances that the interface 104 is determined to be connected, video may continue to be provided to the interface 104. Conversely, in instances that the interface 104 is determined to be unconnected video output to the interface 104 may be disabled. Additionally, in instances that the terminal 104 has been determined to be unconnected, aspects of the invention may enable periodically outputting synthetic video signals or simple pulses to the interface 104 to determine if the interface 104 has been connected since the initial detection.

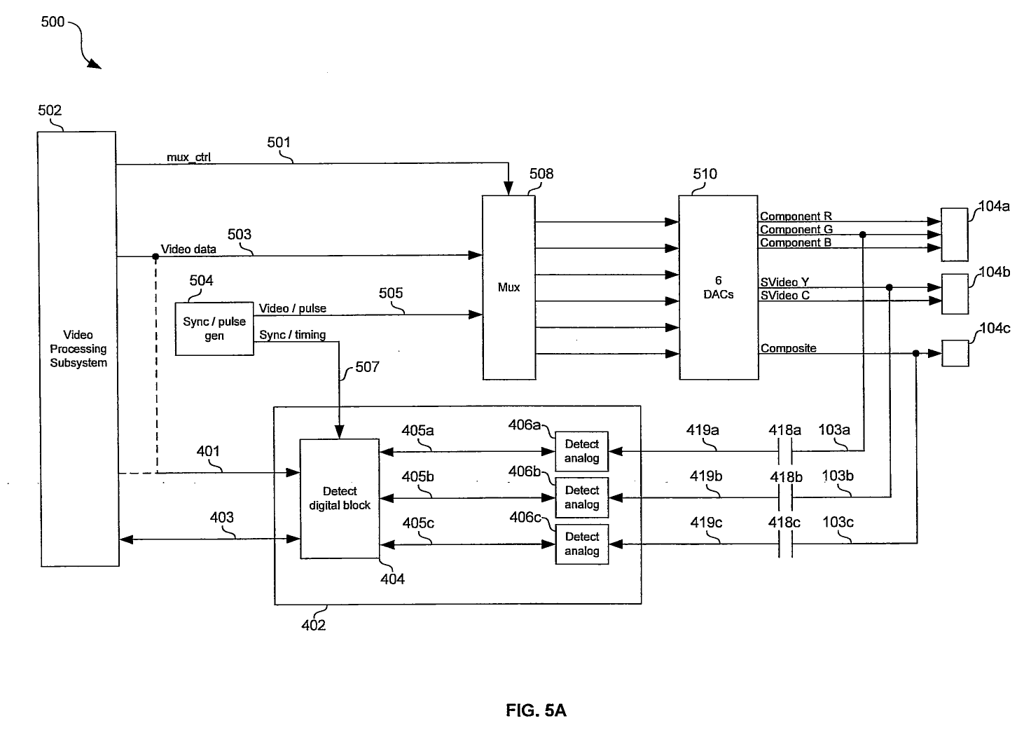

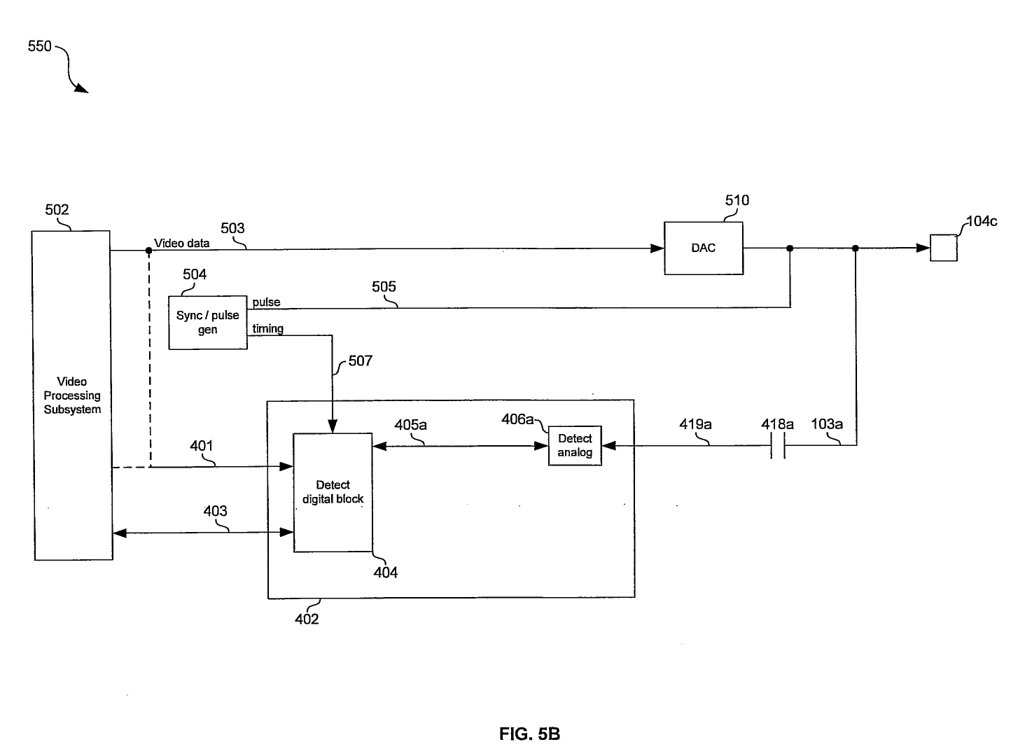

FIG. 5A is a diagram of an exemplary video source enabled to detect video connections, in accordance with an embodiment of the invention. Referring to FIG. 5A there is shown a video processing subsystem 502; a sync/pulse generator 504; a multiplexer 508; DAC 510; interfaces 104a, 104b, and 104c (collectively referred to herein as interfaces 104); capacitors 418a, 418b, and 418c; and a connection detect block 402 comprising a digital portion 404 and analog portions 406a, 406b, and 406c.

The interfaces 104a, 104b, and 104c may each be similar to, or the same as, the interfaces 104a, 104b, and 104c described with respect to FIG. 1.

The capacitors 418a, 418b, and 418 may each be similar to, or the same as, the capacitor 418 described with respect to FIG. 4.

The digital portion 404 may be similar to, or the same as, the digital portion 404 described with respect to FIG. 4.

The analog portions 406a, 406b, and 406c may each be similar to, or the same as, the analog portion 406 described with respect to FIG. 4. In various embodiments of the invention, there may be one analog portion 406 per interface 104. In this regard, for interfaces with multiple connections cable detection may be performed on just one of the connections. For example, as depicted in FIG. 4, detecting whether a component video connection is present may comprise only checking the ‘Green” connection.

The video processing subsystem 502 may comprise suitable logic, circuitry, and/or code that may enable generating video signals for transmission to a receiver. For example, the subsystem 502 may read video information from a disk and decompress, decrypt, decode, deinterlace, or otherwise process the video information to generate a digital video signal 503. Additionally, the video processing subsystem 502 may output a signal 501 for controlling the multiplexer 508. In some embodiments of the invention the video processing subsystem 502 may output Vsync and Hsync signals 401 separate from the signal 503 and in other embodiments of the invention the digital portion 104 may extract the Hsync and Vsync signals from the video signal 503.

The sync/pulse generator 504 may comprise suitable logic, circuitry, and/or code that may enable generating signals which may be utilized to detect a connection status of one or more of the interfaces 104. In some embodiments of the invention, the sync/pulse generator 504 may generate a synthetic video signal comprising Hsync and Vsync signals in accordance with applicable video standards. In such instances, a synthetic video signal 505 and corresponding Hsync and Vsync signals 507 may be output by the sync/pulse generator 504. In other embodiments of the invention, the sync/pulse generator 504 may generate a pulse train which may not be constrained by the amplitude and/or timing specifications of an Hsync signal. In such instances, a pulse train 505 and a corresponding timing signal 507 may be output by the sync/pulse generator 504. In various embodiments of the invention, the reference voltage 411 (see FIG. 4), the time interval Δt (see FIGS. 1 and 4), the duty cycle, and/or frequency of the pulse train generated by the sync/pulse generator 504 may be determined independent of video standards. Accordingly, the pulse train may be a low(er) power alternative to using sync signals because of the ability to reduce the duty cycle, frequency, and/or amplitude of the current pulses. For example, the pulse train may have a frequency on the order of Hz or even sub-Hertz as opposed to Hsync signals which have frequency on the order of 1000's of Hz for many video standards.

The multiplexer 508 may comprise suitable logic, circuitry, and/or code that may enable routing the video signal 503 or the sync/pulse generator output 505 to each channel of the DAC 510. In this regard, whether signal 503 or 505 is routed to each channel of the DAC 510 may be determined based on the control signal 501.

The DAC 510 may comprise suitable logic, circuitry, and/or code that may enable converting digital signals to an analog representation. The DAC 510 may comprise six channels and thus may be enabled to convert each of six digital inputs to a corresponding analog output. In this manner, analog video signals, in accordance with applicable standards, may be output to the interfaces 104.

In operation, the video processing subsystem 502 may output the video signal 503 which may be routed via the multiplexer 508, converted to analog via the DAC 510, and conveyed to a selected (active) interface 104a (104a is chosen for illustration purposes and the active interface may be any of 104a, 104b, and 104c). Accordingly, the video signal 503 may formatted and/or encoded to in accordance with applicable standards of the active interface 104a. Additionally, the sync/pulse generator 504 may output a signal 505 which may be routed via the multiplexer 508, converted to analog via the DAC 510, and conveyed to unselected (inactive) interfaces 104b and 104c. Accordingly, the multiplexer 508 may be configured to route the signal 503 to the active interface 104a and route the signal 505 to the inactive interfaces 104b and 104c.

The active interface 104a may be determined based, at least in part, on a connection status of each of the interfaces 104, as determined by the connection detect block 403. In this regard, determination of the connection status of the interfaces 104 may be as described with respect to FIG. 4 and may comprise measuring ΔV and comparing ΔV to a reference voltage 411. However, the timing and/or amplitude of the signal 505 output by the pulse/current generator 504 may be different than the video signal 503 output by the video processing subsystem 502. Accordingly, when determining a connection status of the active interface 104a, the digital portion 404 may utilize signal 401 to determine a format and timing of the video signals 503. Conversely, when determining a connection status of the inactive interfaces the digital portion 404 may utilize signal 507 to determine a format and/or timing of the synthetic signal 505.

In various embodiments of the invention, a change in the connection status of one or more of the interfaces 104 may result in a different interface becoming the active interface. For example, interface 104a may be the preferred interface but may initially be determined to by unconnected. However, 104a may subsequently be coupled to a receiver and upon detection of the new connection, the interface 104a may become active interface and the interface 104b may become inactive. For example, a change in the ‘status’ signal 403 may generate an “interrupt” in the video processor subsystem 404 causing a reevaluation of which channel should be active.

FIG. 5B is a diagram of another exemplary video source enabled to detect video connections, in accordance with an embodiment of the invention. Referring to FIG. 5b, the video source 550 may be similar to the source 500 described with respect to FIG. 5A. However, the source 550 may be smaller and/or more energy efficient video source. In this regard, the source 550 may comprise only a single video interface and a single channel DAC 510. For example, the source 550 may be a portable media player. Accordingly, detection of whether the video interface 104c may be connected may be utilized to power down the DAC 510 and/or portions of the video processing subsystem 502 to extend the battery life of the portable media player.

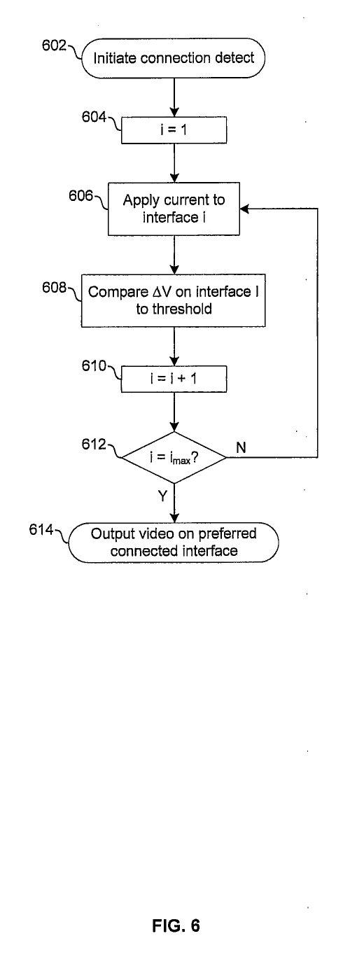

FIG. 6 is a flowchart illustrating exemplary steps for detecting connected video interfaces, in accordance with an embodiment of the invention. Referring to FIG. 6, the exemplary steps may begin with step 602. In step 602, an interface connection routine may be initiated in a video source. In this regard, a video source may, for example, perform a connection detect routine upon powering up or periodically during operation. Subsequent to step 602, the exemplary steps may advance to step 604. In step 604, a counter, i, may be initialized, where each value of i may correspond to a video interface and thus iₘₐₓ may correspond to the total number of analog video interfaces of a video source. Subsequent to step 604, the exemplary steps may advance to step 606. In step 606, a pulse of current may be applied to interface i. In this regard, the pulse may, for example, correspond to an Hsync pulse of a video signal, or may be one or more pulses of a generated pulse train. Subsequent to step 606, the exemplary steps may advance to step 608. In step 608, the voltage, ΔV, on the interface i resulting from the current pulse in step 606 may be compared to a threshold. In instances that ΔV is below a threshold, the interface i may be determined to be connected. In instances that ΔV is above a threshold the interface i may be determined to be unconnected. In various embodiments of the invention, a status bit corresponding to interface i may be asserted in instances that interface i is connected and de-asserted in instances that interface i is unconnected. Subsequent to step 608, the exemplary steps may advance to step 610. In step 610 the counter may be incremented. Subsequent to step 610, the exemplary steps may advance to step 612. In step 612, it may be determined whether i is equal to iₘₐₓ. In this regard, in instances that i is less than iₘₐₓ, then the exemplary steps may return to the previously described step 606.

Returning to step 612, in instances that i is equal to iₘₐₓ, the video source may have checked a connection status of all of its analog video interfaces and the exemplary steps may advance to step 614. In step 614, the video source may select a preferred video interface from the interfaces which were determined to be connected. Accordingly, video may be output via the selected video interface.

Thus, exemplary aspects of a method and system for detection of video connections are provided. In this regard, a pulse of current may be applied to a video interface 104 and a voltage differential ΔV resulting from the applied current pulse may be measured to determine whether the video interface 104 is connected to a video device, such as a video receiver 112. The voltage differential ΔV may be measured by sampling a voltage on the interface during the current pulse (point A of FIG. 1), and subtracting the sampled voltage from a voltage on the interface subsequent to the current pulse (point B of FIG. 1). In instances that ΔV may be less than a threshold, the interface may be determined to be connected. In instances that the voltage differential may be greater than a threshold, the video interface may be determined to be unconnected. The current pulse may be a Hsync pulse 204 of a video signal which may occur during a vertical blanking time of the video signal. A voltage differential resulting from each of a plurality of Hsync pulses 204 occurring over one or more frames of said video signals may be measured. The current pulse may be a pulse in a pulse train generated by a pulse generator 504. A voltage differential resulting from each of a plurality of pulses in a pulse train occurring over a period of time may be measured. A pulse train, instead of a video signal, may be applied to a video interface 104 in instances that the interface may be unconnected. Detecting connected interfaces may enable disabling video signals to unconnected video interfaces.

Another embodiment of the invention may provide a machine-readable storage, having stored thereon, a computer program having at least one code section executable by a machine, thereby causing the machine to perform the steps as described herein for detection of video connections.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
applying a pulse of current to a video interface; and
measuring a voltage differential resulting from said applied current pulse to determine whether said video interface is coupled to a video device.

2. The method according to claim 1, wherein said pulse of current corresponds to a horizontal sync pulse of a video signal.

3. The method according to claim 2, wherein said horizontal sync pulse occurs during a vertical blanking time of said video signal.

4. The method according to claim 2, comprising measuring said voltage differential for a plurality of said horizontal sync pulses occurring over one or more frames of said video signal.

5. The method according to claim 1, wherein said pulse of current is a portion of a pulse train.

6. The method according to claim 5, comprising measuring said voltage differential for a plurality of said pulses in said pulse train.

7. The method according to claim 51 comprising applying said pulse train to said video interface in instances that said video interface was previously determined to be unconnected.

8. The method according to claim 1, comprising disabling video signals to said video interface in instances that said video interface is determined to be unconnected.

9. The method according to claim 1, comprising sampling a voltage on said interface during said pulse of current.

10. The method according to claim 9, comprising subtracting said sampled voltage from a voltage on said interface subsequent to said pulse of current.

11. The method according to claim 1, comprising determining said interface is unconnected when said voltage differential is greater than a threshold.

12. The method according to claim 1, comprising determining said interface is connected when said voltage differential is less than a threshold.

13. A system for signal processing, the system comprising:
one or more circuits in a video source operable to apply a pulse of current to a video interface; and
said one or more circuits are operable to measure a voltage differential resulting from said applied current pulse to determine whether a video device is coupled to said video interface.

14. The system according to claim 13, wherein said pulse of current corresponds to a horizontal sync pulse of a video signal.

15. The system according to claim 14, wherein said horizontal sync pulse occurs during a vertical blanking time of said video signal.

16. The method according to claim 14, wherein said one or more circuits are operable to measure said voltage differential for a plurality of said horizontal sync pulses occurring over one or more frames of said video signal.

17. The method according to claim 13, wherein said pulse of current is a portion of a pulse train.

18. The method according to claim 17, wherein said one or more circuits are operable to measure said voltage differential for a plurality Of said pulses in said pulse train.

19. The method according to claim 17, wherein said one or more circuits are operable to apply said pulse train to said video interface in instances that said video interface was previously determined to be unconnected.

20. The method according to claim 13, wherein said one or more circuits are operable to disable video signals to said video interface in instances that said video interface is determined to be unconnected.

21. The method according to claim 13, wherein said one or more circuits are operable to sample a voltage on said interface during said pulse of current.

22. The method according to claim 21, wherein said one or more circuits are operable to subtract said sampled voltage from a voltage on said interface subsequent to said pulse of current.

23. The method according to claim 13, wherein said one or more circuits are operable to determine said interface is unconnected when said voltage differential is greater than a threshold.

24. The method according to claim 13, wherein said one or more circuits are operable to determine said interface is connected when said voltage differential is less than a threshold.
